(19) United States
(12) Patent Application Publication
(10) Pub. No.: US 2025/0111701 A1
(43) Pub. Date: Apr. 3, 2025

(54) METHODS AND SYSTEMS FOR CAPTURING GENUINE USER IMAGE DATA

(71) Applicant: Daon Technology, Dublin (IE)

(72) Inventors: Mircea IONITA, Dublin (IE); Michael PEIRCE, Dublin (IE)

(21) Appl. No.: 18/479,219

(22) Filed: Oct. 2, 2023

(51) Int. Cl. G06V 40/40; G06T 3/40; G06T 3/60; G06V 10/74; G06V 40/60

(52) U.S. Cl. CPC G06V 40/40; G06T 3/40; G06T 3/60; G06V 10/761; G06V 40/63

(57) ABSTRACT

A method for capturing genuine user image data is provided that includes the steps of creating a displacement instruction, and displaying, by an electronic device, facial image data of a user in accordance with the displacement instruction. Moreover, the method includes the steps of positioning the displayed user facial image data to be located within a screen of the electronic device, capturing facial image data of the user, and calculating a translation distance of the captured user facial image data. Furthermore, the method includes the steps of comparing the calculated translation distance against a translation distance calculated from information in the displacement instruction to determine whether the calculated translation distance is in accordance with the displacement instruction. In response to determining the calculated translation distance is in accordance with the displacement instruction, determining the captured user facial image data is genuine and thus taken of a live person.

### BACKGROUND OF THE INVENTION

This invention relates generally to image data taken of users, and more particularly, to methods and systems for capturing genuine user image data.

Users conduct many different types of transactions with service providers in person and remotely over the Internet. Network-based transactions conducted over the Internet may involve, for example, purchasing items from a merchant website or accessing confidential information from a website. Service providers that own and operate such websites typically require successfully authenticating a user before allowing the user to conduct a desired transaction.

Typically, during network-based biometric authentication transactions conducted with a user at a remote location, the user provides a claim of identity and biometric data. The biometric data is generally captured from the user with a capture device most convenient to the user, for example, the user's smart phone. However, imposters have been known to impersonate users by providing a false claim of identity supported by fraudulent biometric data in an effort to deceive a service provider into concluding the imposter is the person he or she claims to be. Such impersonations are known as spoofing.

Impostors have been known to use many methods to obtain or create fraudulent biometric data of others that can be submitted during authentication transactions. For example, imposters have been known to obtain two-dimensional pictures of others, from social networking sites, and present the obtained pictures to a camera during authentication to support a false claim of identity. Moreover, imposters have been known to eavesdrop on networks during legitimate network-based biometric authentication transactions to surreptitiously obtain genuine image data of a user, and to replay the obtained image data during fraudulent network-based authentication transactions.

Such fraudulent biometric data are known to be difficult to detect using known liveness detection methods. Consequently, accurately conducting network-based authentication transactions with biometric data captured from a user at a remote location depends on verifying the physical presence of the user during the authentication transaction as well as accurately verifying the identity of the user based on the captured biometric data. Verifying that the biometric data presented during a network-based biometric authentication transaction conducted at a remote location is from a live person at the remote location, is known as liveness detection or anti-spoofing.

Liveness detection methods have been known to use structure derived from motion of a biometric modality, such as a person's face, to distinguish a live person from a photograph. Other methods have been known to analyze sequential images of eyes to detect eye blinks and thus determine if an image of a face is from a live person. Yet other methods have been known to illuminate a biometric modality with a pattern to distinguish a live person from a photograph. However, people may not consider these methods to be convenient and these methods may not accurately detect spoofing. As a result, these methods may not provide high confidence liveness detection support for service providers dependent upon accurate biometric authentication transaction results.

Thus, it would be advantageous and an improvement over the relevant technology to provide a method, a computer, and a computer-readable recording medium capable of conveniently detecting liveness of a user attempting to conduct a network-based transaction conducted over the Internet.

### BRIEF DESCRIPTION OF THE INVENTION

In one aspect of the present disclosure, a method for capturing genuine user image data is provided that includes the steps of creating a displacement instruction, and displaying, by an electronic device, facial image data of a user in accordance with the displacement instruction. Moreover, the method includes the steps of positioning the displayed user facial image data to be located within a screen of the electronic device, capturing facial image data of the user, and calculating a translation distance of the captured user facial image data. Furthermore, the method includes the steps of comparing the calculated translation distance against a translation distance calculated from information in the displacement instruction to determine whether the calculated translation distance is in accordance with the displacement instruction. In response to determining the calculated translation distance is in accordance with the displacement instruction, determining the captured user facial image data is genuine and thus taken of a live person.

In one embodiment of the present disclosure, the method further includes the step of determining the captured user facial image data is fraudulent in response to determining the calculated translation is not in accordance with the instruction.

In another embodiment of the present disclosure, the method includes the steps of capturing, by the electronic device, image data of a user without displaying an image of the user on the screen, transmitting the captured image data to a second electronic device, creating the displacement instruction, and transmitting the displacement instruction from the second electronic device to the electronic device.

In yet another embodiment of the present disclosure, the method includes the steps of capturing, by the electronic device, facial image data of a user without displaying an image of the user on the screen and creating the displacement instruction. The displacement instruction includes at least one of translating the captured user facial image data to a non-central location on the screen, rotating the captured user facial image, and scaling the captured facial image data.

In another embodiment of the present disclosure, the method further includes the step of implementing the displacement instructions by cropping a rectangular region of facial image data captured by the electronic device. Wherein the facial image data is captured without being displayed by the electronic device and matching the corners of the cropped region to corners of the screen.

Another aspect of the present disclosure provides a non-transitory computer-readable recording medium in an electronic device for capturing genuine user image data. The non-transitory computer-readable recording medium stores instructions which when executed by a hardware processor performs the steps of the methods described above.

In another aspect of the present disclosure, a computer system for capturing genuine user image data is provided that includes a computer and an electronic device. The computer includes a processor and a memory configured to store data. The computer is associated with a network and the memory is in communication with the processor and has instructions stored thereon. The instructions which, when read and executed by the processor, cause the computer to create a displacement instruction and transmit the displacement instruction to the electronic device via a network. The electronic device displays facial image data of a user in accordance with the displacement instruction, displays the user facial image data within a screen of the electronic device, captures facial image data of the user, and transmits the facial image data to the computer via the network.

Moreover, the instructions when read by the processor further cause the computer to calculate a translation distance of the captured user facial image data, and to compare the calculated translation distance against a translation distance calculated from information in the displacement instruction to determine whether the calculated translation distance is in accordance with the displacement instruction. In response to determining the calculated translation distance is in accordance with the displacement instruction, the captured user facial image data is determined to be genuine and thus was taken of a live person.

In an embodiment of the present disclosure, the instructions when read and executed by the processor, cause the computer to determine the captured user facial image data is fraudulent in response to determining the calculated translation distance is not in accordance with the instructions.

In another embodiment of the present disclosure, the image data of a user is captured without displaying an image of the user on the screen of the electronic device, the displacement instruction is created after the facial image data is received, and the displacement instruction is transmitted from the computer to the electronic device.

In yet another embodiment of the present disclosure, the facial image data of the user is captured without displaying a facial image of the user on the screen of the electronic device, and the displacement instruction is determined based on the capture facial image data.

In another embodiment of the present disclosure, the displacement instructions comprise at least one of translating the captured user facial image data to a non-central location on the screen, translating the captured user facial image data to a central location on the screen, rotating the captured user facial image data, and scaling the captured facial image data.

In yet another embodiment of the present disclosure, the instructions when read and executed by the processor, cause the computer to implement the displacement instructions by cropping a region of image data captured by the electronic device without displaying an image of the user on the screen, and manipulating the corners of the cropped region to correspond to respective corners of the screen.

### BRIEF DESCRIPTION OF THE DRAWINGS

FIG. 1 is a schematic diagram of an example computing system for determining genuineness of captured user image data according to an embodiment of the present disclosure;

FIG. 2 is a diagram of an example electronic device used for determining genuineness of captured user image data according to an embodiment of the present disclosure;

FIG. 3 is an enlarged view of an example screen of the electronic device 10.

FIG. 4 is the enlarged front view of the screen as shown in FIG. 3, further including an example cropping window;

FIG. 5 is the enlarged front view of the screen and an example facial image after implementing an example displacement instruction;

FIG. 6 is an enlarged view of the electronic device with the facial image positioned on the screen as shown in FIG. 5;

FIG. 7 is the enlarged front view of the screen as shown in FIG. 4, including the example cropping window; however, the example cropping window is smaller than the window illustrated in FIG. 4;

FIG. 8 is the enlarged front view of the screen and facial image after implementing a second example displacement instruction;

FIG. 9 is an enlarged view of the electronic device with the facial image positioned on the screen as shown in FIG. 8;

FIG. 10 is the enlarged front view of the screen as shown in FIG. 7, including the example cropping window; however, the cropping window is rotated through an angle theta;

FIG. 11 is the enlarged front view of the screen and facial image after implementing a third example displacement instruction;

FIG. 12 is an enlarged view of the electronic device with the facial image positioned on the screen as shown in FIG. 11;

FIG. 13 is an enlarged view of the electronic device as shown in FIG. 12 further including a visual aid;

FIG. 14 is a flowchart illustrating an example method for creating displacement instructions; and

FIG. 15 is a flowchart illustrating an example method for capturing genuine user image data after implementing the created displacement instructions.

### DETAILED DESCRIPTION OF THE INVENTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the example embodiments described herein can be made without departing from the spirit and scope of the present disclosure.

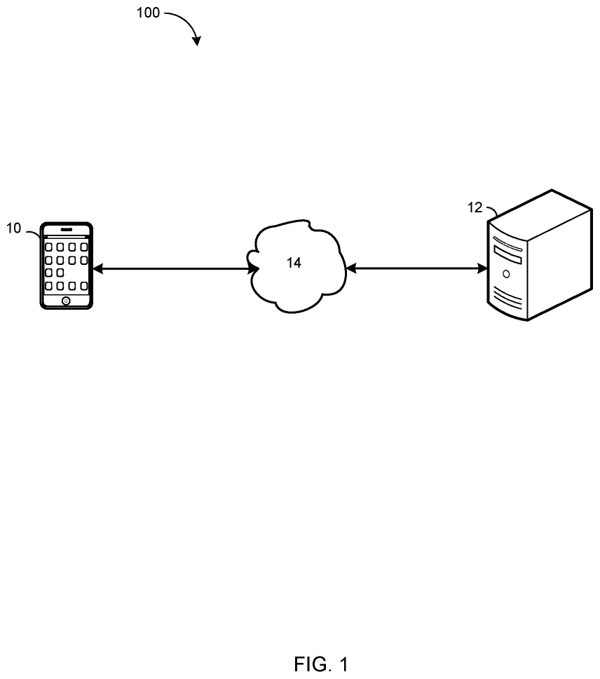

FIG. 1 is a schematic diagram of an example computing system 100 for capturing genuine user image data according to an embodiment of the present disclosure. As shown in FIG. 1, the main elements of the system 100 include an electronic device 10 and a server 12 communicatively connected via a network 14.

In FIG. 1, the electronic device 10 can be any wireless hand-held consumer electronic device capable of at least downloading applications over the Internet, running applications, capturing and storing data temporarily and/or permanently, and otherwise performing any and all functions described herein by any computer, computer system, server or electronic device included in the system 100. One example of the electronic device 10 is a smart phone. Other examples include, but are not limited to, a cellular phone, a tablet computer, a phablet computer, a laptop computer, a camera and any type of hand-held consumer electronic device having wired or wireless networking capabilities capable of performing the functions, methods, and/or algorithms described herein.

The electronic device 10 is typically associated with a single person who operates the device. The person who is associated with and operates the electronic device 10 can be referred to as a user.

The server 12 can be, for example, any type of server or computer implemented as a network server or network computer. The server 12 may alternatively be referred to as an electronic device or an information system. The electronic device 10 may alternatively be referred to as an information system.

The network 14 may be implemented as a 5G communications network. Alternatively, the network 14 may be implemented as any wireless network including, but not limited to, 4G, 3G, Wi-Fi, Global System for Mobile (GSM), Enhanced Data for GSM Evolution (EDGE), and any combination of a LAN, a wide area network (WAN) and the Internet. The network 14 may also be any type of wired network or a combination of wired and wireless networks.

It is contemplated by the present disclosure that the number of electronic devices 10 and servers 12 is not limited to the number of electronic devices 10 and servers 12 shown in the system 100. Rather, any number of electronic devices 10 and servers 12 may be included in the system 100.

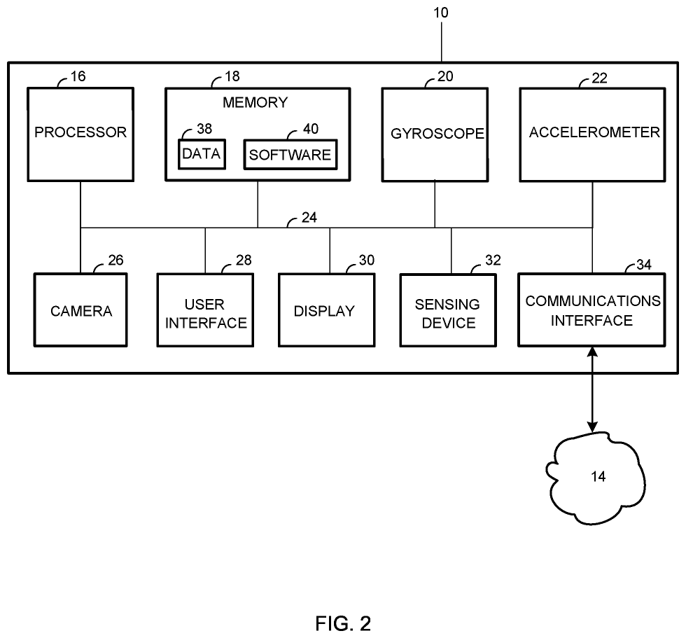

FIG. 2 is a more detailed schematic diagram illustrating the electronic device 10. The electronic device 10 includes components such as, but not limited to, one or more processors 16, a memory 18, a gyroscope 20, an accelerometer 22, a bus 24, a camera 26, a user interface 28, a display 30, a sensing device 32, and a communications interface 34. General communication between the components in the electronic device 10 is provided via the bus 24.

The processor 16 executes software instructions, or computer programs, stored in the memory 18. As used herein, the term processor is not limited to just those integrated circuits referred to in the art as a processor, but broadly refers to a computer, a microcontroller, a microcomputer, a programmable logic controller, an application specific integrated circuit, and any other programmable circuit capable of executing at least a portion of the functions and/or methods described herein. The above examples are not intended to limit in any way the definition and/or meaning of the term “processor.”

The one or more processors 16 may include a trusted platform module to facilitate securely performing functions described herein such as, but not limited to, creating displacement instructions.

The memory 18 may be any non-transitory computer-readable recording medium. Non-transitory computer-readable recording media may be any tangible computer-based device implemented in any method or technology for short-term and long-term storage of information or data. Moreover, the non-transitory computer-readable recording media may be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writeable or re-writeable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), and disc drive or the like. Furthermore, the non-transitory computer-readable recording media may be implemented as smart cards, SIMs, any type of physical and/or virtual storage, or any other digital source such as a network or the Internet from which computer programs, applications or executable instructions can be read.

The memory 18 may be used to store any type of data 36, for example, data records of users. Each data record is typically for a respective user. The data record for each user may include data such as, but not limited to, the user's name, biometric modality data, biometric templates, and personal data. A biometric template can be any type of mathematical representation of biometric modality data. Biometric modality data is the data of a biometric modality of a person. For the methods and systems described herein, the biometric modality is face.

Captured image data may be temporarily or permanently stored in the electronic device 10 or in any device capable of communicating with the electronic device 10 via the network 14. As used herein, capture means to record temporarily or permanently, any data including, for example, biometric modality data of a person.

The term “personal data” as used herein includes any demographic information regarding a user as well as contact information pertinent to the user. Such demographic information includes, but is not limited to, a user's name, age, date of birth, street address, email address, citizenship, marital status, and contact information. Contact information can include devices and methods for contacting the user.

Additionally, the memory 18 can be used to store any type of software 38. As used herein, the term “software” is intended to encompass an executable computer program that exists permanently or temporarily on any non-transitory computer-readable recordable medium that causes the electronic device 10 to perform at least a portion of the functions, methods, and/or algorithms described herein. Application programs are software and include, but are not limited to, operating systems, Internet browser applications, authentication applications, and any other software and/or any type of instructions associated with algorithms, processes, or operations for controlling the general functions and operations of the electronic device 10. The software may also include computer programs that implement buffers and use RAM to store temporary data.

Authentication applications enable the electronic device 10 to conduct user verification and identification (1:C) transactions with any type of authentication data, where “C” is a number of candidates.

The process of verifying the identity of a person is known as a verification transaction. Typically, during a verification transaction a biometric template is generated from biometric modality data of a person captured during the transaction. The generated biometric template is compared against a corresponding record biometric template of the person and a matching score is calculated for the comparison. If the matching score meets or exceeds a threshold score, the identity of the person is verified as true. Alternatively, the captured biometric modality data may be compared against corresponding record biometric modality data to verify the identity of the person. An authentication data requirement is the biometric modality data desired to be captured during a verification or identification transaction.

The camera 26 captures image data. The camera 26 can be one or more imaging devices configured to record image data of at least a portion of the body of a user including any biometric modality of the user while utilizing the electronic device 10. Image data captured using the imaging devices may be used for implementing liveness detection techniques based on depth perception, and if arranged into a three-dimensional (3D) camera system can implement liveness detection techniques based on structural lighting techniques.

The camera 26 is capable of recording image data under any lighting conditions including infrared light. The camera 26 may be integrated into the electronic device 10 as one or more front-facing cameras and/or one or more rear facing cameras that each incorporates a sensor, for example and without limitation, a CCD or CMOS sensor. Alternatively, the camera 26 can be external to the electronic device 10.

The user interface 28 and the display 30 allow interaction between a user and the electronic device 10. The display 30 may include a visual display screen or monitor that displays information. For example, the display 30 may be a Liquid Crystal Display (LCD), an active matrix display, plasma display, or cathode ray tube (CRT). The user interface 28 may include a keypad, a keyboard, a mouse, an illuminator, a signal emitter, a microphone, and/or speakers.

Moreover, the user interface 28 and the display 30 may be integrated into a touch screen display. Accordingly, the display may also be used to show a graphical user interface, which can display various data and provide “forms” that include fields that allow for the entry of information by the user. Touching the screen at locations corresponding to the display of a graphical user interface allows the person to interact with the electronic device 10 to enter data, change settings, control functions, etc. Consequently, when the touch screen is touched, the user interface 28 communicates this change to the processor 16, and settings can be changed, or user entered information can be captured and stored in the memory 18. The display 30 may function as an illumination source to apply illumination to an object while image data for the object is captured.

For user interfaces 28 that include an illuminator, the illuminator may project visible light, infrared light or near infrared light on a biometric modality, and the camera 26 may detect reflections of the projected light off the biometric modality. The reflections may be off of any number of points on the biometric modality. The detected reflections may be communicated as reflection data to the processor 16 and the memory 18. The processor 16 may use the reflection data to create at least a three-dimensional model of the biometric modality and a sequence of two-dimensional digital images. For example, the reflections from at least thirty thousand discrete points on the biometric modality may be detected and used to create a three-dimensional model of the biometric modality. Alternatively, or additionally, the camera 26 may include the illuminator.

The sensing device 32 may include Radio Frequency Identification (RFID) components or systems for receiving information from other devices in the system 100 and for transmitting information to other devices in the system 100. The sensing device 32 may alternatively, or additionally, include components with Bluetooth, Near Field Communication (NFC), infrared, or other similar capabilities. Communications between the electronic device 10 of the user and the server 12 may occur via NFC, RFID, Bluetooth or the like only so a network connection from the electronic device 10 is unnecessary.

The communications interface 34 may include various network cards, and circuitry implemented in software and/or hardware to enable wired and/or wireless communications with other electronic devices 10 (not shown) and the server 12 via the network 16. Communications include, for example, conducting cellular telephone calls and accessing the Internet over the network 14. By way of example, the communications interface 34 may be a digital subscriber line (DSL) card or modem, an integrated services digital network (ISDN) card, a cable modem, or a telephone modem to provide a data communication connection to a corresponding type of telephone line. As another example, the communications interface 34 may be a local area network (LAN) card (e.g., for Ethemet™ or an Asynchronous Transfer Model (ATM) network) to provide a data communication connection to a compatible LAN. As yet another example, the communications interface 34 may be a wire or a cable connecting the electronic device 10 with a LAN, or with accessories such as, but not limited to, other electronic devices. Further, the communications interface 34 may include peripheral interface devices, such as a Universal Serial Bus (USB) interface, a PCMCIA (Personal Computer Memory Card International Association) interface, and the like.

The communications interface 34 also allows the exchange of information across the network 14. The exchange of information may involve the transmission of radio frequency (RF) signals through an antenna (not shown). Moreover, the exchange of information may be between the electronic device 10 and the server 12, other electronic devices (not shown), and other computer systems (not shown) capable of communicating over the network 14.

Examples of other computer systems (not shown) include computer systems of service providers such as, but not limited to, financial institutions, medical facilities, national security agencies, merchants, and authenticators. The electronic devices (not shown) may be associated with any user or with any type of entity including, but not limited to, commercial and non-commercial entities.

The server 12 may include the same or similar components as described herein with regard to the electronic device 10. The server 12 need not include all the same components described herein with regard to the electronic device 10. For example, the server 12 may not include the gyroscope 20 and/or accelerometer 22 or the camera 26.

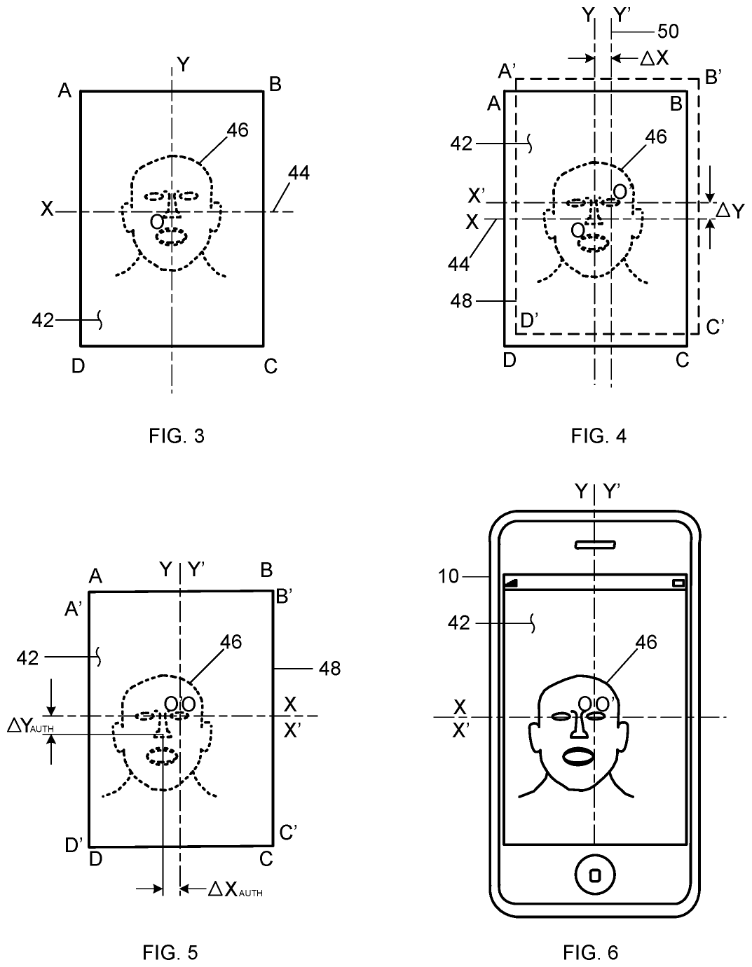

FIG. 3 is an enlarged view of an example screen 42 of the electronic device 10. The screen 42 is typically rectangular so includes four corners A, B, C, and D. The upper left corner may be designated A, the upper right corner may be designated B, the lower left corner may be designated C, and the lower right corner may be designated D. A first cartesian coordinate system 44 having X and Y-axes may be mathematically positioned on the screen 42. An origin O of the cartesian coordinate system 44 may be positioned in the center of the screen 42. Alternatively, the origin O may be mathematically positioned anywhere on the screen 42, for example, in one of the corners A, B, C, or D. Alternatively, or additionally, the cartesian coordinate system 44 may be positioned on a feature of an image displayed on the screen 42. The displayed image may be of any biometric modality including, but not limited to, palm and face. For a facial image such features include, but are not limited to, the tip of the nose, an eye corner, or a mouth corner. A mathematical representation of a facial image 46, captured as part of a video feed but not displayed by the electronic device 10, may be oriented to be in the center of the screen 42. Alternatively, the facial image 46 may be oriented to be in any part of the screen 42. The facial image 46 is shown in dashed lines to indicate that the image 46 is not displayed by the electronic device 10.

FIG. 4 is the enlarged front view of the screen 42 as shown in FIG. 3, further including a rectangular cropping window 48 and a second cartesian coordinate system 50. The cropping window 48 is for defining a region of the facial image 46 in accordance with a displacement instruction. The cropping window 48 graphically represents a displacement instruction.

The four corners of the cropping window 48 may be designated A′, B′, C′ and D′. The upper left corner may be designated A′, the upper right corner may be designated B′, the lower right corner may be designated C′, and the lower left corner may be designated D′. The corners A, B, C, and D correspond to the corners A′, B′, C′ and D′. The cropping window 48 is shown with dashed lines to indicate it is not displayed for a user to see. Additionally, the size of the window 48 may vary. Although the cropping window 48 is rectangular as described herein, it is contemplated by the present disclosure that the cropping window 48 may alternatively have any shape, for example, square, circular, or oval.

The second cartesian coordinate system 50 has X′ and Y′-axes and an origin O′ and is offset from the first cartesian coordinate system 44. The Y′-axis is offset from the Y-axis by a distance ΔX, and the X′-axis is offset form the X-axis by a distance ΔY. The coordinate system 50 may be mathematically positioned anywhere on the cropping window 48. For example, the origin O′ may be positioned at the same point as the origin O, in any corner A, B, C, or D, or may be offset from the origin O by a distance. The distance may be calculated as a vector using the distances ΔX and ΔY. Such a vector would extend between the origin O to the origin O′. Additionally, or alternatively, the origin O′ of the cartesian coordinate system 50 may be positioned on a feature of the image 46, for example, the tip of the nose, an eye corner, or a mouth corner.

The distance ΔX and the distance ΔY may be any distance that facilitates conveniently capturing image data for use in accurately detecting whether the image data 46 was taken of a live person. The distances ΔX and ΔY may be the same or different. It is contemplated by the present disclosure, that a displacement instruction may be created for manipulating the image 46 in any manner that facilitates detecting liveness of users as described herein. The displacement instruction may require translating, scaling and/or rotating the image 46. The displacement instruction may require implementing any combination of X and Y translations, a scale factor, and an angle of rotation. For example, the displacement instruction may require implementing translations only, a rotation angle only, or a scaling factor only. Alternatively, the displacement instruction may require implementing, for example, translations and a rotation angle, translations and a scaling factor, a scaling factor and a rotation angle, or translations, a scaling factor, and a rotation angle. FIG. 4 includes ΔX and ΔY translation distances only, so the displacement instruction for FIG. 4 used ΔX and ΔY translation distances only.

The ΔX distance and the ΔY distance each represent a distance and a direction in which the facial image 46 may be translated across the screen 42. The ΔX and ΔY translation distances, scale factor, and angle of rotation may be random and may be determined in any manner. It is contemplated by the present disclosure that either of the ΔX and ΔY translation distances may be zero.

The scale factor may increase or decrease the size of the image 46 by any amount so long as the image 46 is completely displayed on the screen 42. The image 46 may be rotated clockwise or counterclockwise through an angle between about zero and ten degrees. Alternatively, the image 46 may be rotated through any angle that facilitates detecting whether the image 46 was taken of a live person. The displacement instruction may be determined by any electronic device included in the system 100, for example, the electronic device 10 and the server 12. When the displacement instruction is created by the server 12, the server 12 transmits via the network 14 the displacement instruction to the electronic device 10 for implementation.

FIG. 5 is the enlarged front view of the screen 42 and image 46 in which the displacement instruction has been implemented. More specifically, the corners A′, B′, C′ and D′ of the window 48 have been mathematically manipulated to correspond to the corners A, B, C, and D of the screen 42. As a result, the facial image 46 is translated away from the origin O towards the sides ΔD and DC of the screen 42. Additionally, the cartesian coordinate systems 44 and 50 overlap. The facial image 46 is shown in dashed lines to indicate that it is not displayed by the electronic device 10.

During authentication transactions, most users intuitively understand that the facial image 46 should be centrally located on the screen 42 or should be positioned at any other desirable location in the screen 42. As a result, upon seeing the image 46 most users move the electronic device 10 and/or his or herself so that the displayed facial image 46 is approximately centered in the screen 42 or is positioned at any other desirable location in the screen 42. As described herein, the displayed facial image 46 is to be approximately centered in the screen 42. However, upon seeing the image 42 users may alternatively move the electronic device 10 and/or his or herself so the displayed facial image 46 is positioned at any location in the screen 42.

A point of interest may be any feature in the facial image 46, for example, the tip of the nose, a corner of the mouth or a corner of an eye. As described herein, the point of interest is the tip of the nose. A distance ΔX_{AUTH} and a distance ΔY_{AUTH} may indicate the distance through which the point of interest is to move so the image 46 is centrally located in the screen 42. Alternatively, the distances ΔX_{AUTH} and ΔY AUTH may indicate the distance through which the point of interest is to move so the image 46 is located at any position in the screen 42.

The distances ΔX_{AUTH} and ΔY_{AUTH} may be used to calculate a vector. The vector may be compared against the vector calculated from the distances ΔX and ΔY from the displacement instruction. If the difference between the vectors satisfies a threshold difference, movement for centrally locating the image 46 on the screen 42 may be in accordance with the displacement instruction. As a result, the image 46 may be considered to have been taken of a live person. Otherwise, the image 46 may be considered to have been taken of an imposter. Alternatively, compliance with the displacement instruction may be determined in any manner. For example, the difference between the distances ΔX and ΔX_{AUTH} and/or the difference between the distances ΔY and ΔY_{AUTH} may be calculated and compared against a respective threshold distance. If the threshold distance is satisfied, movement for centrally locating the image 46 on the screen 42 may be in accordance with the displacement instruction. As a result, the image 46 may be considered to have been taken of a live person.

Instead of calculating the distances ΔX_{AUTH} and ΔY_{AUTH} to calculate a vector for comparison against a vector calculated from the distances ΔX and ΔY, coordinates may be used to determine whether the image 46 is centrally located in the screen 42.

FIG. 6 is an enlarged view of the electronic device 10 with the facial image 46 oriented with respect to the screen 42 in the same manner as shown in FIG. 5 before the image 46 is centrally located on the screen 42. The facial image 46 is shown using a solid line to indicate that the image 46 is displayed by the electronic device 10 for the user to see. The displayed facial image 46 facilitates encouraging users to centrally locate the facial image 46 on the screen 42.

Some users may not readily understand that the displayed facial image 46 should be centrally located on the screen 42. Consequently, a message may additionally, or alternatively, be displayed that instructs users to centrally position the displayed facial image 46 on the screen 42. An example message may request the user to move so the image 46 is centrally located on the screen 42. Additionally, the message may be displayed for any length of time, for example, two seconds. Alternatively, the message may be displayed until the displayed facial image 46 is centrally located on the screen 42.

It is contemplated by the present disclosure that the displayed facial image 46 functions as a liveness challenge to which a user responds so the facial image 46 can be centrally located on the screen 42. Image data captured of the facial image 46 while located centrally on the screen 42 in accordance with the displacement instructions, is considered to have been taken of a live person. Hence, the user is considered a live person. Thus, the displayed facial image 46 facilitates conveniently capturing facial image data usable for enhancing the accuracy of user liveness detection and generating trustworthy and accurate verification transaction results.

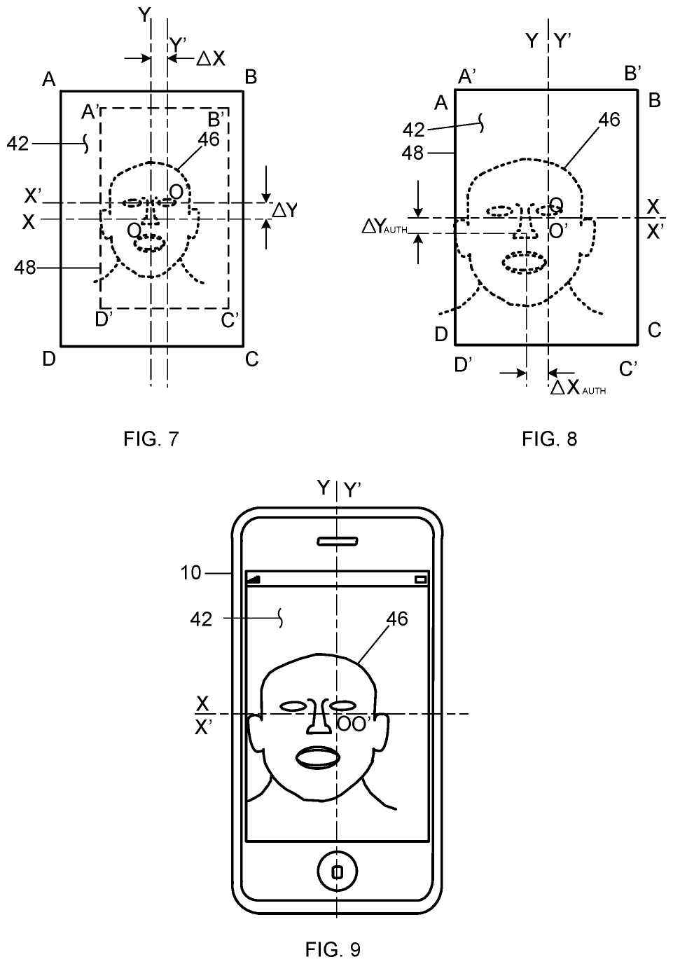

The information shown in FIGS. 7, 8, and 9 is the same information shown in FIGS. 4, 5, and 6, respectively, as described in more detail below. As such, features illustrated in FIGS. 7, 8 and 9 that are identical to features illustrated in FIGS. 4, 5, and 6, respectively, are identified using the same reference numerals used in FIGS. 4, 5, and 6, respectively.

FIG. 7 is the enlarged front view of the screen 42 as shown in FIG. 4, including the rectangular cropping window 48. However, the window 48 is a different size, that is, the window is smaller. However, it is contemplated by the present disclosure that the cropping window 48 may be any other size that facilitates detecting user liveness as described herein. The smaller cropping window 48 may be considered to graphically represent a second displacement instruction for translating and scaling the image 46.

FIG. 8 is an enlarged front view of the screen 42 and image 46 in which the second displacement instruction has been implemented. More specifically, the corners A′, B′, C′ and D′ of the window 48 have been mathematically manipulated to correspond to the corners A, B, C, and D of the screen 42. As a result, the facial image 46 is translated away from the origin O towards the sides AD and DC of the screen 42 and is scaled to be larger. Additionally, the cartesian coordinate systems 44 and 50 overlap.

The distances ΔX_{AUTH} and ΔY_{AUTH} may be used to calculate a vector. The vector may be compared against the vector calculated from the distances ΔX and ΔY from the displacement instruction. If the difference between the vectors satisfies a threshold difference as described herein with regard to FIG. 5, and the image 46 is scaled in accordance with the displacement instruction, the image 46 may be considered to have been taken of a live person. Otherwise, the image 46 is considered to have been taken of an imposter. Because the displacement instruction involves translation and scaling of the image 46, user liveness detection is more rigorous versus translation only.

FIG. 9 is an enlarged view of the electronic device 10 with the facial image 46 oriented with respect to the screen 42 in the same manner as shown in FIG. 8 before the image 46 is centrally located on the screen 42. Image data captured of the facial image 46 while located centrally on the screen 42 in accordance with the displacement instruction, is considered to have been taken of a live person. Hence, the user is considered a live person. Thus, the displayed facial image 46 facilitates conveniently capturing facial image data usable for enhancing the accuracy of user liveness detection and generating trustworthy and accurate verification transaction results.

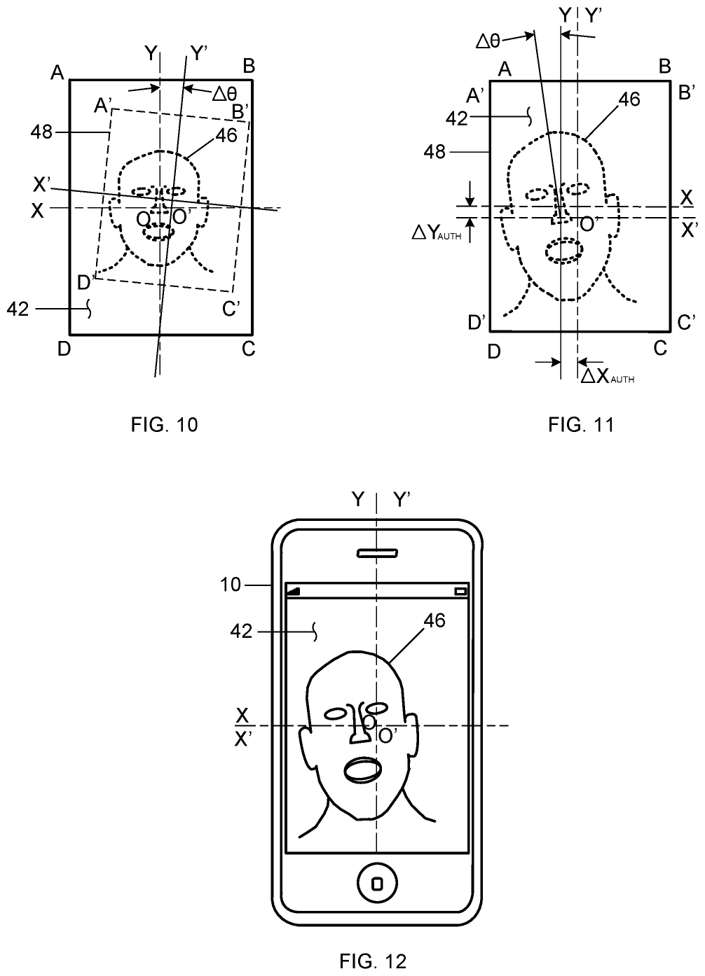

The information shown in FIGS. 10, 11, and 12 is the same information shown in FIGS. 7, 8, and 9, respectively, as described in more detail below. As such, features illustrated in FIGS. 10, 11, and 12 that are identical to features illustrated in FIGS. 7, 8, and 9, respectively, are identified using the same reference numerals used in FIGS. 7, 8, and 9, respectively.

FIG. 10 is the enlarged front view of the screen 42 as shown in FIG. 7, wherein the rectangular cropping window 48 is rotated at an angle theta θ. The angle theta θ is between the Y and Y′-axes and the X and X′-axes. The angle theta θ can be any angle that enables users to conveniently capture facial image data for use in detecting user liveness as described herein. For example, the angle theta θ may be within the range of about zero to fifteen degrees. The rotated cropping window 48 graphically represents a third displacement instruction that when implemented translates, scales, and rotates the image 46. As a result, implementing the third displacement instruction provides more rigorous liveness detection than displacement instructions requiring translation only or a combination of translation and scaling.

FIG. 11 is the enlarged front view of the screen 42 and image 46 in which the third displacement instruction has been implemented. More specifically, the corners A′, B′, C′ and D′ of the cropping window 48 have been mathematically manipulated to correspond to the corners A, B, C, and D of the screen 42. As a result, the facial image 46 is translated away from the origin O towards the sides AD and DC of the screen 42, is scaled to be larger, and is rotated counterclockwise by the angle theta θ. Additionally, the cartesian coordinate systems 44 and 50 overlap.

The distances ΔX_{AUTH} and ΔY_{AUTH} may be used to calculate a vector. The vector may be compared against the vector calculated from the distances ΔX and ΔY from the displacement instruction. If the difference between the vectors satisfies a threshold difference as described herein with regard to FIG. 5, the image 46 is scaled in accordance with the displacement instruction, and the image 46 is rotated in accordance with the displacement instruction, the image 46 may be considered to have been taken of a live person. Otherwise, the image 46 is considered to have been taken of an imposter.

FIG. 12 is an enlarged view of the electronic device 10 with the facial image 46 oriented with respect to the screen 42 in the same manner as shown in FIG. 11. Image data captured of the facial image 46 while located centrally on the screen 42 in accordance with the displacement instruction, is considered to have been taken of a live person. Hence, the user is considered a live person. Thus, the displayed facial image 46 facilitates conveniently capturing facial image data usable for enhancing the accuracy of user liveness detection and generating trustworthy and accurate verification transaction results. Implementing the third displacement instruction provides more rigorous liveness detection than displacement instructions requiring translation only or a combination of translation and scaling.

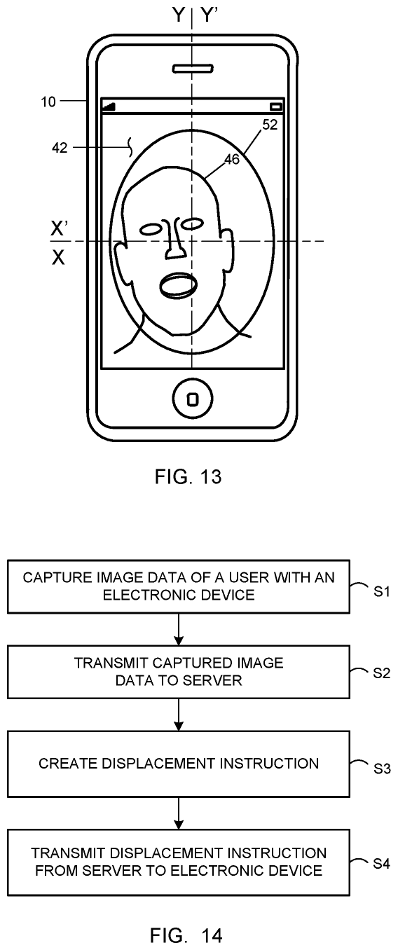

The information shown in FIG. 13 is the same information shown in FIG. 12 as described in more detail below. As such, features illustrated in FIG. 13 that are identical to features illustrated in FIG. 12 are identified using the same reference numerals used in FIG. 12.

FIG. 13 is an enlarged view of the electronic device 10 as shown in FIG. 12 further including a visual aid 52 displayed on the screen 42. The visual aid 52 may be used to define a central region of the screen 42 to which the facial image 46 should be moved in order to properly respond to the challenge.

Typically, during network-based biometric authentication transactions conducted with a user at a remote location, the user provides a claim of identity and biometric data. The biometric data is generally captured from the user with a capture device most convenient to the user, for example, an electronic device 10 associated with the user. However, imposters have been known to impersonate users by providing a false claim of identity supported by fraudulent biometric data to deceive a service provider into concluding the imposter is the person he or she claims to be. Such impersonations are known as spoofing.

Impostors have been known to use many methods to obtain or create fraudulent biometric data of others that can be submitted during authentication transactions. For example, imposters have been known to obtain two-dimensional pictures of others, from social networking sites, and present the obtained pictures to a camera during authentication to support a false claim of identity. Moreover, imposters have been known to eavesdrop on networks during legitimate network-based biometric authentication transactions to surreptitiously obtain genuine image data of a user, and to replay the obtained image data during fraudulent network-based authentication transactions. Such fraudulent biometric data are known to be difficult to detect using known liveness detection methods.

To solve the above problem, a displacement instruction can be created and the electronic device 10 can display the facial image 46 of a user in accordance with the displacement instruction. The electronic device 10 can locate the facial image 46 within the screen 42 of the electronic device 10 and capture facial image data of the user. Additionally, the electronic device 10 can calculate the translation of the captured user facial image data and compare the calculated translation against the displacement instruction to determine whether the calculated translation is in accordance with the displacement instruction. In response to determining the calculated translation is in accordance with the displacement instruction, the electronic device 10 can determine that the captured user facial image data is genuine and thus taken of a live person.

FIG. 14 is a flowchart illustrating an example method and algorithm for creating a displacement instruction. The electronic device 10 can implement the instruction during an authentication transaction initiated by a user desiring to conduct a remote transaction. FIG. 14 illustrates example operations performed when the electronic device 10 and the server 12 run software stored in their respective memories.

In step S1, the software 40 executed by the processor 16 of the electronic device 10 causes the electronic device 10 to capture facial image data of a user, and in step S2, to transmit the captured facial image data to the server 12 via the network 14. Next, in step S3, the software executed by the processor of the server 12 causes the server 12 to create a displacement instruction and, in step S4, to transmit the displacement instruction to the electronic device 10 via the network 14.

The displacement instruction may be digitally signed before being transmitted to the electronic device 10. Additionally, the displacement instruction may be encrypted before being transmitted to the electronic device 10. The displacement instruction may include a time stamp. When the displacement instruction includes a time stamp, the displacement instruction including the time stamp may be encrypted. It is contemplated by the present disclosure that the displacement instruction may be digitally signed and encrypted. As a result of digitally signing the displacement instruction, encrypting the displacement instruction, or both digitally signing and encrypting the displacement instruction, a record of the instruction does not need to be stored and a state about the instruction need not be maintained by the entity that created the instruction. The entity that created the instruction can validate that the instruction originated from the entity by using one or more of the digital signature, encrypted instruction, and timestamp. Doing so reduces the complexity and thus increases the efficiency of systems used by the entity to create the instruction.

It is contemplated by the present disclosure, that a displacement instruction may be created for manipulating the image 46 in any manner that facilitates detecting liveness of users as described herein. The displacement instruction may require translating, scaling and/or rotating the image 46. The displacement instruction may require implementing any combination of X and Y translations, a scale factor, and an angle of rotation. For example, the displacement instruction may require implementing, for example, translations and a rotation angle, translations and a scaling factor, a scaling factor and a rotation angle, or translations, a scaling factor, and a rotation angle. Alternatively, the displacement instruction may require implementing, for example, translations only, a rotation angle only, or a scaling factor only.

Although the example method and algorithm for creating a displacement instruction is performed by the electronic device 10 and the server 12, it is contemplated by the present disclosure that the electronic device 10 may alternatively use the captured facial image data to create the displacement instruction without transmitting any data to the server 12.

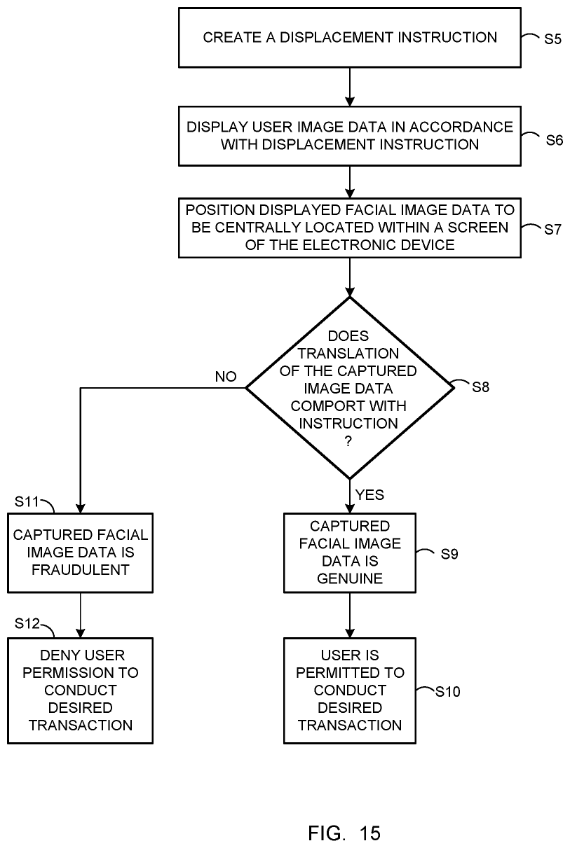

FIG. 15 is a flowchart illustrating an example method and algorithm for capturing genuine image data of a user after a displacement instruction has been implemented by the electronic device 10. When a user desires to conduct a network-based transaction, the user may be required to prove he or she is live before being permitted to conduct the transaction. Example network-based transactions include, but are not limited to, buying merchandise from a merchant service provider website, accessing services available on government websites, and accessing a bank or brokerage account to, for example, check the account balance or make a trade or conduct research. FIG. 15 illustrates example operations performed when the electronic device 10 captures image data of a user and determines whether the captured image data was taken of a live person. The example method and algorithm of FIG. 15 also includes steps that may be performed by, for example, the software 40 executed by the processor 12 of the electronic device 10.

In step S5, the software 40 executed by the processor 16 of the electronic device 10 causes the electronic device 10 to create a displacement instruction and, in step S6, to display facial image data of a user in accordance with the displacement instruction. The displacement instruction may be digitally signed by the electronic device 10. Next, in step S7, in response to user input moving the electronic device 10 and/or his or herself with respect to the electronic device 10, the software 40 executed by the processor 16 causes the electronic device 10 to centrally position the facial image data on the screen 42 and to capture facial image data of the user. Alternatively, the facial image data may be positioned at any location in the screen 42 prior to capturing facial image data of the user.

In step S8, the software 40 executed by the processor 16 causes the electronic device 10 to determine whether the displacement of the captured image data comports with the displacement instructions. More specifically, the electronic device 10 compares a vector calculated from the ΔX and ΔY translations included in the instructions against another vector calculated from the translations ΔX_{AUTH} and ΔY_{AUTH} created by implementing the displacement instruction. If the difference between the vectors is less than or equal to a threshold, in step S9, the captured image data is considered to have been captured of a live person. Hence, the user is considered a live person and in step S10 is permitted to conduct the desired transaction. Instead of calculating vectors from translations, the vectors may be calculated from coordinates.

However, if the difference between the vectors is less than a threshold, in step S11 the captured image data is considered fraudulent and in step S12 the user is denied permission to conduct the desired transaction.

Using the method and algorithm for capturing genuine image data of a user facilitates conveniently capturing facial image data usable for enhancing the accuracy of user liveness detection. As a result, the accuracy and trustworthiness of verification transaction results are facilitated to be enhanced.

The example methods and algorithms described herein may be conducted entirely by the electronic device 10, and partly by the electronic device 10 and partly by the server 12 via the network 14. Additionally, the methods and algorithms described herein may be conducted partly by the electronic device 10, partly by the server 12 and partly by any other computer or electronic device included in the computing system 100 via the network 16. Moreover, the example methods described herein may be conducted entirely on other computer systems (not shown) and other electronic devices 10 (not shown). Thus, it is contemplated by the present disclosure that the example methods and algorithms described herein may be conducted using any combination of computers (not shown), computer systems (not shown), and electronic devices (not shown). Furthermore, data described herein as being stored in the electronic device 10 may alternatively, or additionally, be stored in the server 12, or in any computer system (not shown) or electronic device (not shown) operable to communicate with the electronic device 10 over the network 14.

Additionally, the example methods and algorithms described herein may be implemented with any number and organization of computer program components. Thus, the methods and algorithms described herein are not limited to specific computer-executable instructions. Alternative example methods and algorithms may include different computer-executable instructions or components having more or less functionality than described herein.

The example methods and/or algorithms described above should not be considered to imply a fixed order for performing the method and/or algorithm steps. Rather, the method and/or algorithm steps may be performed in any order that is practicable, including simultaneous performance of at least some steps. Moreover, the method and/or algorithm steps may be performed in real time or in near real time. It should be understood that for any method and/or algorithm described herein, there can be additional, fewer, or alternative steps performed in similar or alternative orders, or in parallel, within the scope of the various embodiments, unless otherwise stated. Furthermore, the invention is not limited to the embodiments of the methods and/or algorithms described above in detail.

What is claimed is:

1. A method for capturing genuine user image data comprising:
creating a displacement instruction;
displaying, by an electronic device, facial image data of a user in accordance with the displacement instruction;
positioning the displayed user facial image data to be located within a screen of the electronic device;
capturing facial image data of the user;
calculating a translation distance of the captured user facial image data;
comparing the calculated translation distance against a translation distance calculated from information included in the displacement instruction to determine whether the calculated translation distance is in accordance with the displacement instruction; and
in response to determining the calculated translation distance is in accordance with the displacement instruction, determining the captured user facial image data is genuine and thus taken of a live person.

2. The method in accordance with claim 1 further comprising the step of determining the captured user image data is fraudulent in response to determining the calculated translation distance fails to be in accordance with the displacement instruction.

3. The method in accordance with claim 1, said step of creating a displacement instruction comprising the steps of:
capturing, by the electronic device, facial image data of the user without displaying a facial image of the user on the screen;
transmitting the captured image data to a second electronic device;
creating the displacement instruction; and
transmitting the displacement instruction from the second electronic device to the electronic device.

4. The method in accordance with claim 1, said step of creating a displacement instruction comprising the steps of:
capturing, by the electronic device, facial image data of the user without displaying an image of the user on the screen; and
determining, by the electronic device, the displacement instruction.

5. The method in accordance with claim 1, wherein the displacement instruction comprises at least one of:
translating the captured user facial image data to a non-central location on the screen;
translating the captured user facial image data to a central location on the screen;
rotating the captured user facial image data; and
scaling the captured user facial image data.

6. The method in accordance with claim 1, further comprising the steps of:
cropping a rectangular region of facial image data captured by the electronic device, wherein the facial image data is captured without being displayed by the electronic device; and
manipulating the corners of the cropped region to correspond to respective corners of the screen.

7. A computer system for capturing genuine user image data comprising a computer and an electronic device, wherein the computer comprises:
a processor; and
a memory configured to store data, said computer being associated with a network and said memory being in communication with said processor and having instructions stored thereon which, when read and executed by said processor, cause said computer to:
create a displacement instruction;
transmit the displacement instruction to said electronic device via the network, wherein said electronic device:
displays facial image data of a user in accordance with the displacement instruction, positions the displayed user facial image data within a screen of said electronic device,
captures facial image data of the user, and
transmits the facial image data to the computer via the network;
calculate a translation distance of the captured user facial image data;
compare the calculated translation distance against a translation distance calculated from information in the displacement instruction to determine whether the calculated translation distance is in accordance with the displacement instruction; and
in response to determining the calculated translation distance is in accordance with the displacement instruction, determine the captured user facial image data is genuine and thus taken of a live person.

8. The computer system according to claim 7, wherein the instructions when read and executed by said processor, cause said computer to determine the captured user facial image data is fraudulent in response to determining the calculated translation distance fails to be in accordance with the displacement instruction.

9. The computer system according to claim 7, wherein:
the facial image data of the user is captured without displaying a facial image of the user on the screen of said electronic device;
the displacement instruction is created after the captured facial image data is received; and
the displacement instruction is transmitted from said computer to said electronic device.

10. The computer system according to claim 7, wherein:
the facial image data of the user is captured without displaying a facial image of the user on the screen of said electronic device; and
the displacement instruction is determined based on the captured facial image data.

11. The computer system according to claim 7, wherein the displacement instruction comprises at least one of:
translating the captured user facial image data to a non-central location on the screen;
translating the captured user facial image data to a central location on the screen;
rotating the captured user facial image data; and
scaling the captured user facial image data.

12. The computer system according to claim 7, wherein the instructions when read and executed by said processor, cause said computer to:
crop a rectangular region of facial image data captured by said electronic device, wherein the facial image data is captured without being displayed by said electronic device; and
manipulate the corners of the cropped region to correspond to respective corners of the screen.

13. A non-transitory computer-readable recording medium in an electronic device for capturing genuine user image data, the non-transitory computer-readable recording medium storing instructions which when executed by a hardware processor cause the non-transitory recording medium to perform steps comprising:
creating a displacement instruction;
displaying facial image data of a user in accordance with the displacement instruction;
positioning the displayed user facial image data to be located within a screen of the electronic device;
capturing facial image data of the user;
calculating a translation distance of the captured user facial image data;
comparing the calculated translation distance against a translation distance calculated from information in the displacement instruction to determine whether the calculated translation distance is in accordance with the displacement instruction; and
in response to determining the calculated translation distance is in accordance with the displacement instruction, determining the captured user facial image data is genuine and thus taken of a live person.

14. The non-transitory computer-readable recording medium according to claim 13, wherein the instructions when read and executed by said processor, cause said non-transitory computer-readable recording medium to perform a step of determining the captured user image data is fraudulent in response to determining the calculated translation distance fails to be in accordance with the displacement instruction.

15. The non-transitory computer-readable recording medium according to claim 13, wherein the instructions when read and executed by said processor, cause said non-transitory computer-readable recording medium to perform the steps of:
capturing facial image data of the user without displaying a facial image of the user on the screen;
transmitting the captured image data to a second electronic device;
creating the displacement instruction; and
transmitting the displacement instruction from the second electronic device to the electronic device.

16. The non-transitory computer-readable recording medium according to claim 13, wherein the instructions when read and executed by said processor, cause said non-transitory computer-readable recording medium to perform the steps of:
capturing facial image data of the user without displaying an image of the user on the screen; and
determining the displacement instruction.

17. The non-transitory computer-readable recording medium according to claim 13, wherein the displacement instruction comprises at least one of:
translating the captured user facial image data to a non-central location on the screen;
translating the captured user facial image data to a central location on the screen;
rotating the captured user facial image data; and
scaling the captured user facial image data.

18. The non-transitory computer-readable recording medium according to claim 13, wherein the instructions when read and executed by said processor, cause said non-transitory computer-readable recording medium to perform the steps of:
cropping a rectangular region of facial image data captured by the electronic device, wherein the facial image data is captured without being displayed by the electronic device; and
manipulating the corners of the cropped region to correspond to respective corners of the screen.
